(19) United States
(12) Patent Application Publication
(10) Pub. No.: US 2022/0339619 A1
(43) Pub. Date: Oct. 27, 2022

(54) Method for Desorbing Carbon Dioxide from Polymeric Organic Anion Exchangers

(71) Applicant: LANXESS Deutschland GmbH, Cologne (DE)

(72) Inventors: Christian Ochsmann, Dueren (DE); Stefan Neumann, Leverkusen (DE)

(73) Assignee: LANXESS Deutschland GmbH, Cologne (DE)

(21) Appl. No.: 17/640,863

(22) PCT Filed: Sep. 1, 2020
(86) PCT No.: PCT/EP2020/074349

§ 371 Date: Mar. 7, 2022

(30) Foreign Application Priority Data
Sep. 6, 2019 (EP) 19195943.6

(51) Int. Cl. B01J 49/07; B01D 53/04; B01J 49/40; B01J 41/14

(52) U.S. Cl. CPC B01J 49/07; B01D 53/0462; B01J 49/40; B01J 41/14; B01D 2253/206; B01D 2257/504

(57) ABSTRACT

The invention relates to a process for desorbing carbon dioxide from polymeric organic anion exchangers having primary and/or secondary amine groups, to which the carbon dioxide is bound in the form of carbamate, by means of heating through microwave radiation.

The invention relates to a process for desorbing carbon dioxide from polymeric organic anion exchangers having primary and/or secondary amine groups, to which the carbon dioxide is bound in the form of carbamate, by means of heating through microwave radiation.

WO-A-00/02643 describes a regenerative process for the adsorption of CO₂. This employs a macroporous ion exchanger having primary benzylamine groups. The process removes from respired air the carbon dioxide that is being continuously produced through metabolism. The CO₂-rich air is directed by a blower through a bed of ion-exchange resin. On flowing through the bed, the CO₂ molecules bind to the primary benzylamine functional groups, with corresponding depletion of the medium flowing through. The regeneration of the resin and thus the desorption of CO₂ can be effected by means of slightly superheated steam under atmospheric conditions or by a negative pressure, with or without heating, or by means of heated or unheated CO₂-free air.

EP-B-2490789 describes a macroporous crosslinked polystyrene-divinylbenzene-based ion exchanger having primary benzylamine groups produced by alkaline hydrolysis of phthalimide groups that is suitable for removing CO₂ from syngases. The carbon dioxide molecules are here primarily chemically bonded to the polymer matrix through carbamate formation. The bound CO₂ is desorbed again by varying the temperature, through the so-called “temperature swing”, or by a combination of temperature (temperature swing) and pressure variation, (pressure swing).

WO-A-2018/233949 also discloses basic anion exchangers having primary benzylamine groups produced by alkaline hydrolysis of phthalimide groups that can be used for CO₂ removal. Also described in WO-A-2018/233949 is the desorption of the CO₂ bound to the anion exchanger by means of slightly superheated steam under atmospheric conditions or by a negative pressure, with or without heating, or by means of heated or unheated CO₂-free air.

The nature of the desorption of CO₂ bound to ion exchangers by chemisorption, physisorption and/or chemically depends inter alia on the course of the pressure distribution and/or temperature distribution that needs to be present in the ion exchanger for desorption of the CO₂. When using any of the known desorption methods described above, this is often uneven or/and too slow and therefore inefficient. There therefore remained a need for a process for desorbing CO₂ from polymeric organic anion exchangers having primary and/or secondary amine groups with which the disadvantages of the prior art can be overcome.

It has surprisingly been found that heating by means of microwave radiation can bring about desorption of CO₂ from special polymeric organic anion exchangers having primary and/or secondary amine groups, allowing the disadvantages of the prior art to be overcome. This was particularly surprising since it is known from Meredith R. J. (1998), Engineers' Handbook of Industrial Microwave Heating, Exeter, p. 29, The Institution of Engineering and Technology, London, United Kingdom, Lightning Source UK Ltd., printed in the UK by Short Run Press Ltd. that polystyrene is unsuitable for heating by means of microwave radiation. The microwave absorption coefficient, which is a measure of the ability of a material to absorb microwaves, is only 0.3 tan αδ×10³ for polystyrene, whereas it is 169 tan αδ×10³ for water, which is known to be very efficiently heated by means of microwaves.

The invention accordingly relates to a process for desorbing carbon dioxide from at least one anion exchanger comprising a polystyrene copolymer having functional groups of the formula (I)

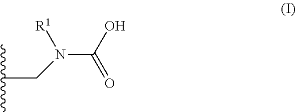

where [symbol] represents a polystyrene copolymer scaffold and R¹ may be C₁ to C₆ alkyl and/or H and the methylene group in the formula (I) that is attached to the nitrogen atom is attached to an aromatic moiety in the polystyrene copolymer, by increasing the temperature by means of microwave radiation and optionally by reducing the pressure.

The polystyrene copolymer of the anion exchanger comprising polystyrene copolymers having functional groups of the formula (I) is preferably crosslinked. A crosslinked polystyrene copolymer is also referred to as a bead polymer. The polystyrene copolymer of the anion exchanger comprising polystyrene copolymers having functional groups of the formula (I) is particularly preferably a crosslinked styrene/divinylbenzene copolymer.

The degree of crosslinking in the crosslinked polystyrene copolymer of the anion exchangers comprising polymers having functional groups of the formula (I) is preferably 1% by weight to 80% by weight, more preferably 2% by weight to 25% by weight, and is the percentage ratio of the mass of the employed crosslinking multiethylenically unsaturated monomers to the total mass of all monomers. The degree of crosslinking is very particularly preferably 2% by weight to 10% by weight.

In the present preferred case in which the anion exchanger comprising polystyrene copolymers having functional groups of the formula (I) is a crosslinked styrene/divinylbenzene copolymer, the monomers to be used in the production process are styrene and divinylbenzene.

As the anion exchanger comprising polystyrene copolymers having functional groups of the formula (I), it is possible to use microporous or gel-like and macroporous anion exchangers.

The terms microporous or gel-like and macroporous are known from the specialist literature, for example from Seidl et al., Adv. Polymer Sci., vol. 5, pp. 113-213 (1967).

For the purposes of the invention, the term macroporous means that the anion exchanger comprising polystyrene copolymers having functional groups of the formula (II) has an average pore diameter of preferably 100 to 900 angstroms, more preferably of 100 to 550 angstroms.

Preference is given to using macroporous anion exchangers comprising polystyrene copolymers having functional groups of the formula (I).

The anion exchangers comprising polystyrene copolymers having functional groups of the formula (I) are very particularly preferably macroporous crosslinked styrene/divinylbenzene copolymers in which R₁ is hydrogen.

The anion exchanger comprising polystyrene copolymers having functional groups of the formula (I) is preferably loaded with 0.2 to 3.0 moles of CO₂ per kg of dried anion exchanger.

The anion exchanger comprising polystyrene copolymer having functional groups of the formula (I) is preferably produced by adsorption of carbon dioxide on at least one anion exchanger comprising polystyrene copolymers having functional groups of the formula (II)

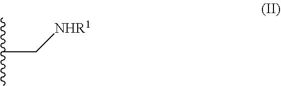

where [symbol] represents a polystyrene copolymer scaffold and R¹ is C₁ to C₆ alkyl and/or H, and the methylene group in the formula (II) that is attached to the nitrogen atom is attached to an aromatic moiety in the polystyrene copolymer.

R¹ is preferably methyl, ethyl, n-propyl, s-propyl, n-butyl, s-butyl, t-butyl or hydrogen. Particularly preferably, le is hydrogen.

The polystyrene copolymer of the anion exchanger comprising polystyrene copolymers having functional groups of the formula (II) is preferably crosslinked. Particularly preferably, the polystyrene copolymer of the anion exchanger comprising polystyrene copolymers having functional groups of the formula (II) is a crosslinked styrene/divinylbenzene copolymer.

The degree of crosslinking in the crosslinked polystyrene copolymer of the anion exchangers comprising polymers having functional groups of the formula (II) is preferably 1% by weight to 80% by weight, more preferably 2% by weight to 25% by weight, and is the percentage ratio of the mass of the employed crosslinking multiethylenically unsaturated monomers to the total mass of all monomers. The degree of crosslinking is very particularly preferably 2% by weight to 10% by weight.

Divinylbenzene is a multiethylenically unsaturated monomer.

In the present preferred case in which the anion exchanger comprising polystyrene copolymers having functional groups of the formula (II) is a crosslinked styrene/divinylbenzene copolymer, the monomers to be used in the production process are styrene and divinylbenzene.

Preference is given to using macroporous anion exchangers comprising polystyrene copolymers having functional groups of the formula (II).

The anion exchangers comprising polystyrene copolymers having functional groups of the formula (II) to be used in the process for the adsorption of carbon dioxide may be present in heterodisperse or monodisperse form.

In the present application, monodisperse materials are those in which at least 90% by volume or 90% by mass of the particles have a diameter within ±10% of the most common diameter. For example, in the case of an anion exchanger comprising polystyrene copolymers having functional groups of the formula (II) in which the beads have a most common diameter of 0.50 mm, at least 90% by volume or 90% by mass are within a size range between 0.45 mm and 0.55 mm or, in the case of an anion exchanger comprising polystyrene copolymers having functional groups of the formula (II) in which the beads have a most common diameter of 0.70 mm, at least 90% by volume or 90% by mass are within a size range between 0.63 mm and 0.77 mm.

In the present application, heterodisperse particle distributions are all those in which the particles are not distributed according to the definition of a monodisperse distribution.

In the process for adsorbing carbon dioxide, preference is given to using heterodisperse anion exchangers comprising polystyrene copolymers having functional groups of the formula (II).

The anion exchangers comprising polystyrene copolymers having functional groups of the formula (II) are very particularly preferably macroporous crosslinked styrene/divinylbenzene copolymers in which R¹ is hydrogen.

The anion exchangers comprising polystyrene copolymers having functional groups of the formula (II) that are used in the process for the adsorption of carbon dioxide preferably have an average particle diameter of 200 μm to 650 μm.

The anion exchangers comprising polystyrene copolymers having functional groups of the formula (II) that are used in the process for the adsorption of carbon dioxide preferably have a surface area of 40 to 60 m²/g measured according to the DIN ISO 9277 method for determining BET surface area.

The functionalization of polystyrene copolymers obtainable according to the prior art to anion exchangers comprising polymers having functional groups of the formula (II) is likewise known from the prior art to those skilled in the art.

The functionalization can take place for example by the so-called phthalimide method, in which the crosslinked polystyrene copolymer is first amidomethylated with phthalimide derivatives and the amidomethylated polystyrene copolymer is converted by alkaline hydrolysis into an anion exchanger comprising polystyrene copolymers having functional groups of the formula (II) with primary amino groups. In this case, le is hydrogen. This can then be converted by alkylation into anion exchangers having secondary amino groups.

Functionalization by the phthalimide method likewise forms part of the prior art and is described for example in EP-B-1078688.

Functionalization can however likewise be achieved by chloromethylation and subsequent amination. For the production of anion exchangers having primary and/or secondary amino groups, the chloromethylated bead polymer is thus reacted with ammonia, a primary amine such as methylamine or ethylamine, or a secondary amine such as dimethylamine.

The concentration of primary amino groups is preferably 0.2 to 3 mol/1 in the anion exchanger comprising polystyrene copolymers having functional groups of the formula (II). Particularly preferably, the concentration of primary amino groups in the anion exchanger comprising polystyrene copolymers having functional groups of the formula (II) is 1.0 to 2.5 mol/1.

Very particularly preferably, the anion exchanger comprising polystyrene copolymers having functional groups of the formula (II) contains primary amino groups.

Macroporous anion exchangers comprising polystyrene copolymers having functional groups of the formula (II) are preferably produced according to the so-called phthalimide method, by
a) converting monomer droplets composed of at least styrene and divinylbenzene and also a porogen and at least one initiator into a macroporous crosslinked polystyrene copolymer,
b) amidomethylating this macroporous crosslinked polystyrene copolymer with phthalimide derivatives, and
c) converting the amidomethylated polymer into an anion exchanger comprising polystyrene copolymer having functional groups of the formula (II) in which R₁=H.

Examples of suitable initiators are peroxy compounds such as dibenzoyl peroxide, dilauroyl peroxide, bis(p-chlorobenzoyl) peroxide, dicyclohexyl peroxydicarbonate, tert-butyl peroctoate, tert-butyl peroxy-2-ethylhexanoate, 2,5-bis(2-ethylhexanoylperoxy)-2,5-dimethylhexane or tert-amylperoxy-2-ethylhexane, and also azo compounds such as 2,2′-azobis(isobutyronitrile) or 2,2′-azobis(2-methylisobutyronitrile).

The initiators are preferably used in amounts of from 0.05% to 2.5% by weight, more preferably from 0.1% to 1.5% by weight, based on the monomer mixture.

In the production of anion exchangers comprising polystyrene copolymers having functional groups of the formula (II), porogens are used as further additives to create a macroporous structure in the polymer. Organic solvents are suitable for this purpose, since they dissolve or swell the resulting polymer only poorly (precipitants for polymers). Preference is given to hexane, octane, isooctane, isododecane, methyl ethyl ketone, butanol or octanol and isomers thereof. Particular preference is given to using isododecane as porogen.

The anion exchangers comprising polystyrene copolymers having functional groups of the formula (II) are usually present in aqueous solution after their production The water content can be adjusted as appropriate by drying. It is however also possible to adjust the water content of the anion exchangers comprising polystyrene copolymers having functional groups of the formula (II) by contacting with a water-containing gas stream. Preference is given to adjustment of the water content by drying.

The water content in the anion exchanger comprising polystyrene copolymers having functional groups of the formula (II) can be determined using a dry balance. This means that the wet anion exchanger comprising polystyrene copolymers having functional groups of the formula (II) is heated with infrared light until no further decrease in mass is registered or the desired moisture content has been established. The amount of residual moisture can be calculated therefrom. If the water content is to be determined during the uptake of carbon dioxide, this is normally determined from the mass balance after penetration of water vapor, from the amount of total moisture and the moisture content of the anion exchanger comprising polystyrene copolymers having functional groups of the formula (II).

The scope of the invention encompasses all hereinabove and hereinbelow recited definitions of radicals, parameters, and elucidations that are of a general nature or stated within preferred ranges, in any combination with one another, i.e. including between the respective ranges and preferred ranges.

### Adsorption of Carbon Dioxide

The anion exchangers comprising polystyrene copolymers having functional groups of the formula (II) employed in the process for the adsorption of CO₂ preferably have a water content of from 0% by weight to 40% by weight, more preferably from 1% by weight to 20% by weight, based on the total mass of the anion exchanger comprising polystyrene copolymers having functional groups of the formula (II). Very particularly preferably, the anion exchanger comprising polystyrene copolymers having functional groups of the formula (II) has a water content of from 0.1% by weight to 3% by weight.

Particularly preferably, the macroporous anion exchangers comprising polystyrene copolymers having functional groups of the formula (II) in which R₁=hydrogen have a water content of 1% by weight to 40% by weight based on the total mass of the anion exchanger.

Preferably, anion exchangers comprising polystyrene copolymers having functional groups of the formula (II) are contacted with carbon dioxide-containing gases and converted into anion exchangers comprising polystyrene copolymers having functional groups of the formula (I).

These gases may be for example an industrial gas, such as preferably flue gas or offgas from burning hydrocarbons, natural gas, syngas, cracked gas or biogas. Particularly preferably, adsorption is carried out with carbon dioxide in the presence of air.

The gases preferably contain 0.1% by volume to 60% by volume of carbon dioxide. The gases used for adsorption of carbon dioxide on the anion exchanger comprising polystyrene copolymers having functional groups of the formula (II) particularly preferably contain 25% by volume to 60% by volume of carbon dioxide based on the total volume of the employed gases.

The gas preferably contains 0% by volume to 40% by volume of water. The water content of the gas is particularly preferably 0.1% by volume to 20% by volume.

The adsorption and reactions of carbon dioxide-containing gases with the anion exchanger comprising polystyrene copolymers having functional groups of the formula (II) preferably takes place at temperatures of from 0° C. to 30° C.

The adsorption and reactions of carbon dioxide-containing gases with the anion exchanger comprising polystyrene copolymers having functional groups of the formula (II) can take place at any desired pressures.

The anion exchanger comprising polystyrene copolymers having functional groups of the formula (II) is loaded at a flow rate preferably of 100 bed volumes per hour to 300 bed volumes per hour.

The anion exchanger comprising polystyrene copolymers having functional groups of the formula (I) is preferably loaded with 0.2 to 3.0 moles of CO₂ per kg of dried anion exchanger.

### Desorption of Carbon Dioxide

Desorption is in the process of the invention carried out by increasing the temperature by means of microwave radiation. The microwave radiation is preferably generated using velocity modulation tubes, klystrons, traveling-wave tubes or cavity magnetrons.

The device most commonly used in technology for microwave heating is the cavity magnetron. Preference is given to using a cavity magnetron for generation of the microwaves for heating the anion exchanger having functional groups of the formula (I). The employed frequency of the microwave radiation is preferably 2 to 3 GHz, more preferably 2.4 to 2.5 GHz. The energy of the microwave radiation for heating the anion exchanger having functional groups of the formula (I) is preferably 1 kW to 1000 kW. The temperature necessary for regeneration of the anion exchanger having functional groups of the formula (I) is preferably 50° C. to 180° C. During regeneration, a vacuum can optionally be applied to reduce the CO₂ partial pressure and to promote CO₂ desorption. The possible pressures during regeneration are preferably 10⁻³ mbar to standard pressure. Regeneration to the anion exchanger comprising polystyrene copolymers having functional groups of the formula (II) preferably takes place over a period of 30 minutes to 60 minutes.

Very particularly preferably, the anion exchanger comprising polystyrene copolymers having functional groups of the formula (I) has a water content of from 0.1% by weight to 3% by weight. The process of the invention permits for the first time efficient desorption of carbon dioxide from anion exchangers comprising polystyrene copolymers having functional groups of the formula (I).

### EXAMPLES

### Example 1

A macroporous crosslinked anion exchanger comprising styrene/divinylbenzene copolymers having functional groups of the formula (II) and having a content of primary amine groups of 1.0 to 2.5 mol/1, a degree of crosslinking of 2% to 10%, and a pore diameter of 100 to 550 angstroms was used. The anion exchanger was dried and contained 2% water when used.

In the laboratory experiment carried out, the anion exchanger having functional groups of the formula (II) was introduced into a quartz-glass column in a microwave test reactor. The microwave test reactor consisted of a hollow stainless steel cylinder in which the quartz-glass column was fitted, such that the ion exchanger could be irradiated with microwaves by means of a microwave antenna likewise fitted inside the stainless steel cylinder at a distance of 7 cm from the quartz-glass column. The assembly is additionally provided with a means of generating a vacuum inside the microwave reactor and the quartz-glass column. The quartz-glass column used shows very low microwave absorption (tan αδ×10³) within a range from 5 to 7.

15 ml (7.5 g) of anion exchanger comprising styrene/divinylbenzene copolymers having functional groups of the formula (II) was used and contacted with a continuous stream of 50% by volume of CO₂ and 50% by volume of air (input concentration) with a total throughput of 3 1/h (specific speed 200 BV/h). CO₂ loading is 2.0 mol per kg of dried anion exchanger.

After loading the anion exchanger having functional groups of the formula (II) with CO₂ under atmospheric conditions, the resin was then 100% regenerated by applying a vacuum of 0.1 mbar and by heating the adsorber to 90° C. using microwave radiation. Regeneration was carried out for a period of 40 min, after which no more CO₂ release could be measured.

The adsorbed amount of CO₂ was released again in its entirety by the ion exchanger.

The real dielectric constant ε′ and complex dielectric constant ε″ of a CO₂-saturated, dried anion exchanger comprising polystyrene copolymers having functional groups of the formula (I) was measured at room temperature according to J. Krupka, T. Zychowicz, V. Bovtun, and S. Veljko, “Complex Permittivity Measurements of Ferroelectrics Employing Composite Dielectric Resonator Technique”, IEEE Transactions on Ultrasonics, Ferroelectrics and Frequency Control, pp. 1883-1888, vol. 53, No 10, October 2006 in order to calculate therefrom the microwave absorption coefficient (tan αδ×10³). The ratio of the two dielectric constants constitutes, as loss angle tan αδ=ε″/ε′, a measure of the ability of a bed of an anion exchanger to absorb microwave radiation and thus to be heated. This is surprisingly 34.4 tan αδ×10³ and is accordingly significantly higher than the value that would have been expected for polystyrene (0.3 tan αδ×10³, source: Meredith R. J. (1998), Engineers' Handbook of Industrial Microwave Heating, Exeter, p. 29 The Institution of Engineering and Technology, London, United Kingdom, Lightning Source UK Ltd., printed in the UK by Short Run Press Ltd.

The anion exchanger comprising polystyrene copolymers having functional groups of the formula (I) therefore allows heating and regeneration by means of microwave radiation.

1. A process comprising desorbing carbon dioxide from at least one anion exchanger comprising polystyrene copolymers having functional groups of the formula (I) 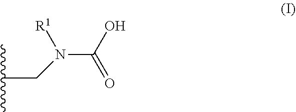
where [symbol] represents a polystyrene copolymer scaffold and
R¹ may be C₁ to C₆ alkyl and/or H and the methylene group in the formula (I) that is attached to the nitrogen atom is attached to an aromatic moiety in the polystyrene copolymer, wherein said desorbing comprises increasing the temperature by means of microwave radiation and optionally by reducing the pressure.

2. The process according to claim 1, wherein R¹ is methyl, ethyl, n-propyl, s-propyl, n-butyl, s-butyl, t-butyl or hydrogen.

3. The process according to claim 1, wherein the polystyrene copolymer scaffold of the anion exchanger comprising polystyrene copolymers having functional groups of the formula (I) is a crosslinked styrene/divinylbenzene copolymer.

4. The process according to claim 1, wherein the anion exchanger comprising polystyrene copolymers having functional groups of the formula (I) comprises a bead polymer having a pore diameter of 100 to 550 angstroms.

5. The process according to claim 1, wherein R¹ is hydrogen.

6. The process according to claim 1, wherein the anion exchanger comprising polystyrene copolymers having functional groups of the formula (I) contains 0.2 to 3.0 moles of CO₂ per kg of dried anion exchanger.

7. The process according to claim 1, wherein the desorbing is carried out at temperatures of from 50° C. to 180° C.

8. The process the desorbing is carried out at pressures of from 10⁻³ mbar to standard pressure.

9. The process according to claim 1, wherein the energy of the microwave radiation is from 1 kW to 1000 kW.

10. The process according to claim 1, wherein the anion exchanger of the formula (I) is produced by the reaction with carbon dioxide of an anion exchanger comprising polystyrene copolymers having functional groups of the formula (II) 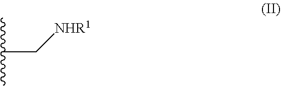
where [symbol] and R¹ are as defined above.

11. The process according to claim 10, wherein carbon dioxide-containing gases are adsorbed.

12. The process as claimed in claim 11, wherein the gases contain 0.1% by volume to 60% by volume of carbon dioxide based on the total volume of the employed gases.

13. The process according to claim 11, wherein the water content of the gas is 0.1% by volume to 20% by volume.

14. The process according to claim 10, wherein the water content of the anion exchangers comprising polystyrene copolymers having functional groups of the formula (II) shows 1% by weight to 20% by weight based on the total mass of the anion exchangers.

15. The process according to claim 10, wherein the adsorption of carbon dioxide on the anion exchanger comprising polystyrene copolymers having functional groups of the formula (II) takes place at temperatures of from 0° C. to 30° C.
